(19) United States
(12) Patent Application Publication
(10) Pub. No.: US 2022/0270015 A1
(43) Pub. Date: Aug. 25, 2022

(54) AGRICULTURAL ASSISTANCE MOBILE APPLICATIONS, SYSTEMS, AND METHODS

(71) Applicants: David M. Vanderpool, Dallas, TX (US); David Stallings Vanderpool, Fair Grove, MO (US)

(72) Inventors: David M. Vanderpool, Dallas, TX (US); David Stallings Vanderpool, Fair Grove, MO (US)

(21) Appl. No.: 17/181,468

(22) Filed: Feb. 22, 2021

(51) Int. Cl. G06Q 10/06; G06K 9/00; G06Q 50/02

(52) U.S. Cl. CPC G06Q 10/06375; G06K 9/00657; G06Q 50/02; G06K 2009/00644

(57) ABSTRACT

Systems and methods for agricultural assistance are provided. An agricultural assistance system may measure spectral data for crops, determine crop information including a first crop type based on the spectral data, receive supplementary data, and recommend a second crop type based on the crop information and supplementary data. The agricultural assistance system may also provide crop information to a user based on the spectral data and the supplementary data.

### SUMMARY

In certain embodiments of the present disclosure, a method includes measuring spectral data of crops on a plot of land via an electromagnetic radiation sensor, determining crop information (e.g., crop type) based on the spectral data, receiving supplemental data (e.g., geographical data, climate data, weather data, soil data, and market data), and recommending, via a user interface, a second crop type that is different than the first crop type to a first user based, at least in part, on the crop information and the supplemental data.

In a variation thereof, the electromagnetic radiation sensor includes at least one of a satellite or a drone. In further variation thereof, the spectral data comprises infrared wavelength data. In a still further variation thereof, the step of determining the crop information is carried out by comparing the spectral data to a table of spectral crop data, the table configured to correspond the spectral data to the crop information.

In another variation thereof, the crop information further includes a crop health and a crop yield. In yet another variation thereof, the step of recommending a suggested crop type is further based on a nutrition level for a population. In still another variation thereof, the method further includes a step of aggregating crop information from a plurality of farms and providing the aggregated crop information to the second user.

In certain embodiments of the present disclosure, a method for computing and distributing crop data is disclosed. The method includes sensing spectral data for a plurality of crops on a plurality of farms via at least one satellite; retrieving supplemental data comprising at least one of geographical data, climate data, weather data, soil data, market data, or historical data; computing crop data for each of the plurality of farms based, at least in part, on the spectral data and supplemental data; and sending the crop data of the plurality of farms to a user.

In a variation thereof, the crop data includes at least one of crop type, expected yield, or crop health. In a further variation thereof, the method further includes the step of computing a potential profit based on the market data and the expected yield.

In another variation thereof, the method includes the step of recommending a crop type to the user based on the crop data and the supplemental data.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a schematic of an agricultural assistance system, in accordance with certain embodiments of the present disclosure.

FIG. 2 shows a block diagram of inputs and outputs from an agricultural assistance system of FIG. 1.

FIG. 3 shows a simplified version of a user interface for using the agricultural system of FIG. 1.

FIG. 4 shows a block diagram of steps of a method for providing an agricultural recommendation, in accordance with certain embodiments of the present disclosure.

FIG. 5 shows a block diagram of components of a system for carrying out the method of FIG. 4, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope the appended claims.

### DETAILED DESCRIPTION

In many developing countries, agriculture is the main source of income and food for a large percentage of the population. Of this population of farmers, small farms make up the majority of farms. For small farms, it is challenging to invest in technology to improve factors such as crop yields. Further, farms—whether small, mid-size, or large—are at a technological disadvantage when it comes to using data to improve operations. At best, in some countries, farmers may rely on organizations to collect survey results about crops and other farms, but such surveys take time to carry out and the results quickly become outdated and not useful.

In addition to challenges for individual farmers, governments can struggle to determine or predict whether current planted crops will be sufficient for the food and economic needs of the country. For example, it can be challenging to determine what types and volume of crops have been planted, the health of the planted crops, and/or whether disease or other factors will negatively affect the health and volume of crops in an upcoming harvest.

Certain embodiments of the present disclosure are accordingly directed to technology for improving operations of farms and/or assessment of crops at multiple farms. In some embodiments, approaches are described for recommending types of crops based, at least in part, on data from multiple sources. In some embodiments, approaches are described for recommending chemicals (e.g., pesticide such as insecticides, herbicides and fungicides) or fertilizers to be applied to crops.

Agricultural Assistance System

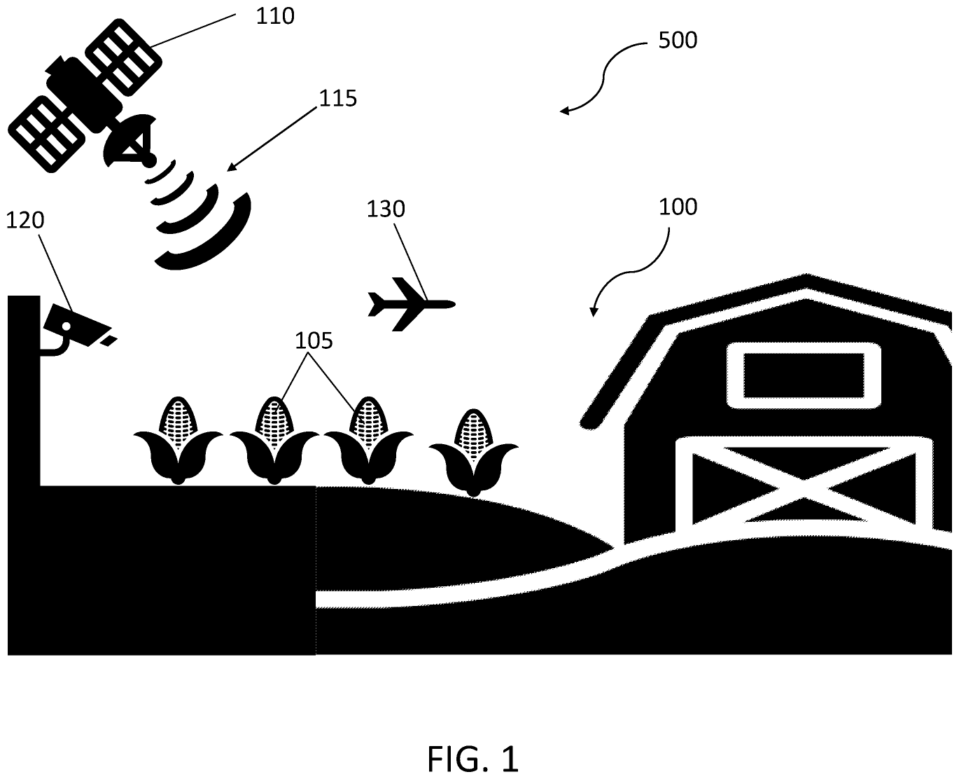

FIG. 1 shows a simplified view of an agricultural assistance system 500 according to an exemplary embodiment. Agricultural assistance system 500 is configured to be used on a plot of land 100, which may be a field, orchard, grove, forest, greenhouse, garden, or any other area on which plants 105 are grown. In the illustrated embodiment, the land 100 is a farm and the plants 105 are crops.

The agricultural assistance system 500 comprises an electromagnetic radiation sensor 110, which in the illustrated embodiment is represented by a satellite with one or more sensors configured to measure electromagnetic radiation 115. The electromagnetic radiation sensor 110 may be configured to measure intensity, frequency, location, wavelength, or any combination thereof of any electromagnetic radiation such as gamma rays, x-rays, ultraviolet radiation, visible light, infrared radiation, microwaves, or any combination thereof. The electromagnetic radiation sensor 110 may comprise a passive sensor, active sensor, thermal sensor, photonic sensor, quantum sensor, imaging sensor, or any combination thereof.

The agricultural assistance system 500 also optionally comprises additional sensors such as a land-based sensor 120, and/or an aerial sensor 130. The land-based sensor 120 and aerial sensor 130 may be configured to measure electromagnetic radiation in the same way as electromagnetic radiation sensor 110, measure electromagnetic radiation in finer detail than electromagnetic radiation sensor 110, visually record features of land 100, provide real-time data, provide more frequent or more specific data than electromagnetic radiation sensor 110, monitor a certain number of plots 100, or any combination thereof. The electromagnetic radiation sensor 110, land-based sensor 120, and/or the aerial sensor 130 may comprise multiple sensors configured to detect multiple wavelengths of light, such as visible, infrared (IR), near IR (NIR), ultraviolet (UV), and specific wavelength ranges within each of those categories. The electromagnetic radiation sensor 110, land-based sensor 120, and/or aerial sensor 130 may also filter out unwanted radiation and may be configured to correct sensor readings based on incident sunlight and various atmospheric and weather conditions. In some embodiments, the aerial sensor 130 is positioned on a drone and is configured to monitor certain plots of land and may be activated when requested by a user or may operate passively. An example of the aerial sensor 130 is the P4 Multispectral drone available from DJI.

Input Data

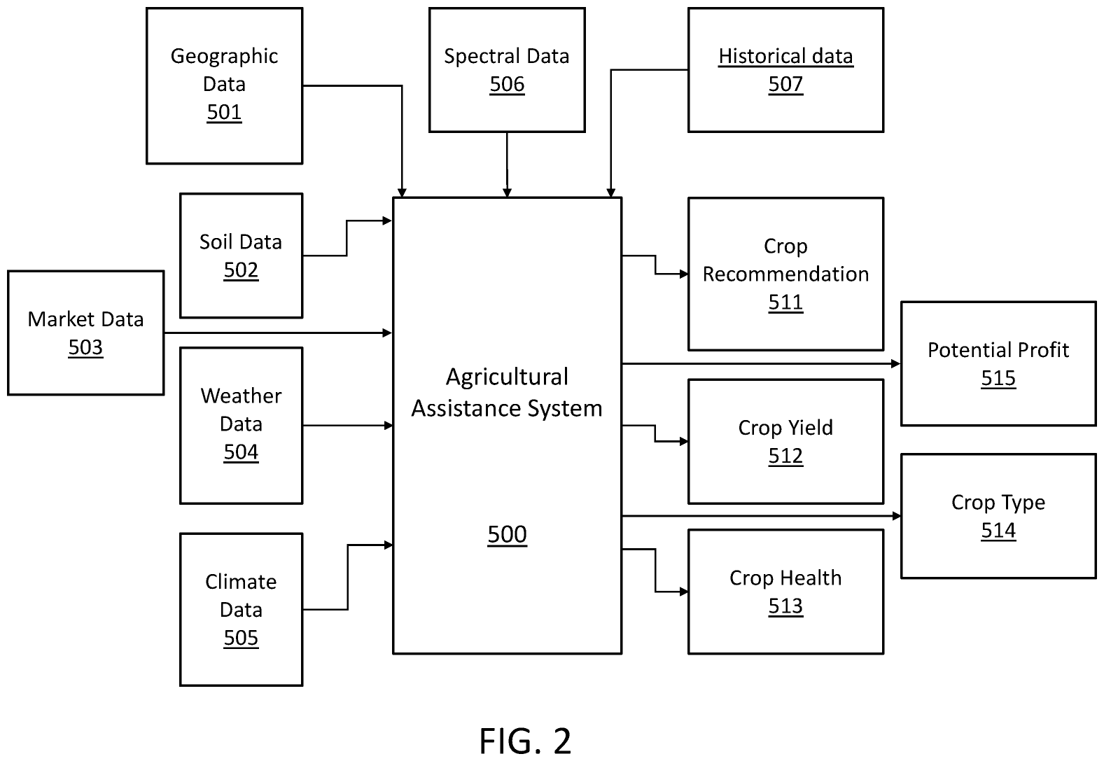

FIG. 2 shows a block diagram of potential inputs and outputs for the agricultural assistance system 500. Each of the illustrated inputs and outputs are optional, and furthermore additional inputs and outputs may be part of the overall system. In the illustrated embodiment, the agricultural assistance system 500 receives input data/information and provides a user with a variety of outputs. Exemplary inputs include, but are not limited to, geographic data 501, soil data 502, market data 503, weather data 504, climate data 505, spectral data 506, and historical data 507, each of which are described in more detail herein. Together, the geographic data 501, soil data 502, market data 503, weather data 504, climate data 505, and historical data 507 may be described as supplemental data. Each of the inputs may be provided by a user, retrieved from a database, sensed, recorded, and/or measured from a component of the agricultural assistance system 500.

Geographic data 501 generally comprises information related to the geography of the area. For example, the geographic data 501 may comprise coordinates of land 100 (e.g., latitude and longitude), municipal information related to land 100 (e.g., state, city, country, county, province), information related to type of land on which land 100 is located (e.g., plains, mesas, river deltas, coast), and/or any other type of location information. Geographic data 501 may also comprise information related to the topographical information of an area, such as drainage arrays. For example, geographic data 501 may provide agricultural assistance system 500 with information that land 100 is positioned in a low-lying area, on a plain, in a river basin, along a coastline, etc.

Soil data 502 may comprise information related to the soil within land 100, such as soil type, soil composition, nitrogen levels, depth, moisture levels, and any other information related to soil. Soil data 502 may be measured by a user (e.g., via one or more types of soil meters) and then inputted into agricultural assistance system 500 or may be estimated/inferred based on other inputs to agricultural assistance system 500 such as geographic data 501, spectral data 506, or historical data 507.

The market data 503 may comprise information related to general market prices or availability related to the plants 105. Market data 503 may be obtained from a database of market information, such as crop prices and stocks. A user may also input a selling price for their own plants 105, and/or cost information related to planting, growing, and harvesting plants 105.

The weather data 504 may comprise information related to the weather around or at the land 100 within a period of hours, days, weeks, or months. Weather data 504 may come from a weather database and/or may be based on predictive models. The weather data 504 can include rainfall data. The climate data 505 may comprise long-term climate data for a region and may predict general weather patterns or trends on a scale of weeks, months, seasons, or years. Climate data 505 may comprise average temperatures, average humidity levels, average precipitation levels (rainfall, snowfall, etc.), average sunlight exposure, seasonal information, and combinations thereof.

The spectral data 506 may comprise data transmitted from the electromagnetic radiation sensor 110, land-based sensor 120, and/or aerial sensor 130 as described above, and may comprise any spectral information related to plants 105.

The historical data 507 may comprise any data related to historical growth of plants 105 on land 100 or any specific type of plant in other locations. For example, historical data 507 may comprise information related to previous harvests or growth cycles within or around land 100 or may comprise historical growth data for a specific type of crop or plant based on information from other farms or plots of land.

Outputs

Based on at least some of the inputs, the agricultural assistance system 500 can calculate a number of outputs which may be then provided to a user. Outputs may include, but are not limited to, a crop recommendation 511, a crop yield 512, a crop health 513, a crop type 514, and a potential profit 515. The crop recommendation 511, crop yield 512, crop health 513, crop type 514, and potential profit 515 may be considered to be or referred to as crop information.

In certain embodiments, the crop recommendation 511 includes suggestions or recommendations to a user related to planting a certain type of plants 105. As one example, the soil data 502 and the climate data 505 may be compared to a database of types of crops and their optimal growth conditions to determine what type of crop should be planted in the given soil. As another example, agricultural assistance system 500 provide a crop recommendation 511 based on climate data 505 and geographic data 501. As an illustrative example, geographic data 501 may indicate that the land 100 is in a low lying area with poor drainage, and climate data 505 may indicate that the land 100 typically has a warm, humid climate, and agricultural assistance system 500 may provide a crop recommendation 511 of planting rice on the land 100. Agricultural assistance system 500 may provide multiple crop recommendations 511 based on different sets of data, and each crop recommendation 511 may be sorted based on a selected data type. For example, multiple crop recommendations 511 may be sorted based on geographic data 501, soil data 502, weather data 504, and/or climate data 505. Agricultural assistance system 500 may provide different crop recommendations 511 based on the data inputs it receives. As an example, agricultural assistance system 500 may recommend a first crop recommendation based on geographic data 501 and climate data 505, and a second crop recommendation based on soil data 502.

In certain embodiments, the crop recommendation 511 includes suggestions or recommendations to a user for taking action to improve the health or yield of plants 105 (e.g., use of a fertilizer, type and quantity of fertilizer, watering cycles, crop rotations, planting/harvesting times). As one example, if the agricultural assistance system 500 has determined that crops in surrounding farms have been affected by a certain pest or disease, the crop recommendation 511 can recommend a particular chemical for applying to the crops or recommend that crops be harvested by a certain date to avoid the pests or disease. As another example, if agricultural assistance system 500 has determined a crop type 514, it may also provide a fertilizer recommendation as part of crop recommendation 511. Fertilizer recommendations may be provided based on fertilizer manufacturer recommendations for a given crop type 514.

The agricultural assistance system 500 may also estimate/predict crop yield 512. Crop yield 512 may comprise a predicted amount of plant 105 that may be harvested at the end of growth. For example, the agricultural assistance system 500 may provide a user with an estimated weight of crop that is expected to be produced. Crop health 513 may comprise health information related to plants 105. In some embodiments, agricultural assistance system 500 may calculate crop health 513 based on spectral data 506 by comparing spectral data 506 to tabulated data.

The agricultural assistance system 500 may also calculate crop type 514 based on spectral data 506. Crop type 514 comprises information related to a type of plant 105 within land 100. For example, the agricultural assistance system 500 may use spectral data 506 to determine what crop is growing on each plot of land within the scope of agricultural assistance system 500.

The agricultural assistance system 500 may also calculate potential profit 515 based on crop yield 512 and market data 503. Potential profit 515 may comprise a total net profit, and/or a potential income based on the amount of plants expected to be grown on land 100 and information related to the price and/or availability of said plants..

Additionally, agricultural assistance system 500 may aggregate crop information from a plurality of plots of land 100 and provide aggregated information to a user. As an example, agricultural assistance system 500 may aggregate information from a plurality of plots of land 100 and may provide crop information to a second user who oversees the plurality of plots of land 100. As an example, the second user may be a landowner, manager, or governing body. The second user may then relay the crop information to a number of first users associated with each of the plots of land 100. Additionally, the agricultural assistance system 500 may provide crop information to the first users directly instead of, or in addition to, providing the crop information to the second user. As an example, the first user may be a farmer, an owner/manager of a single plot of land, or an owner/manager of multiple plots of land.

User Interface

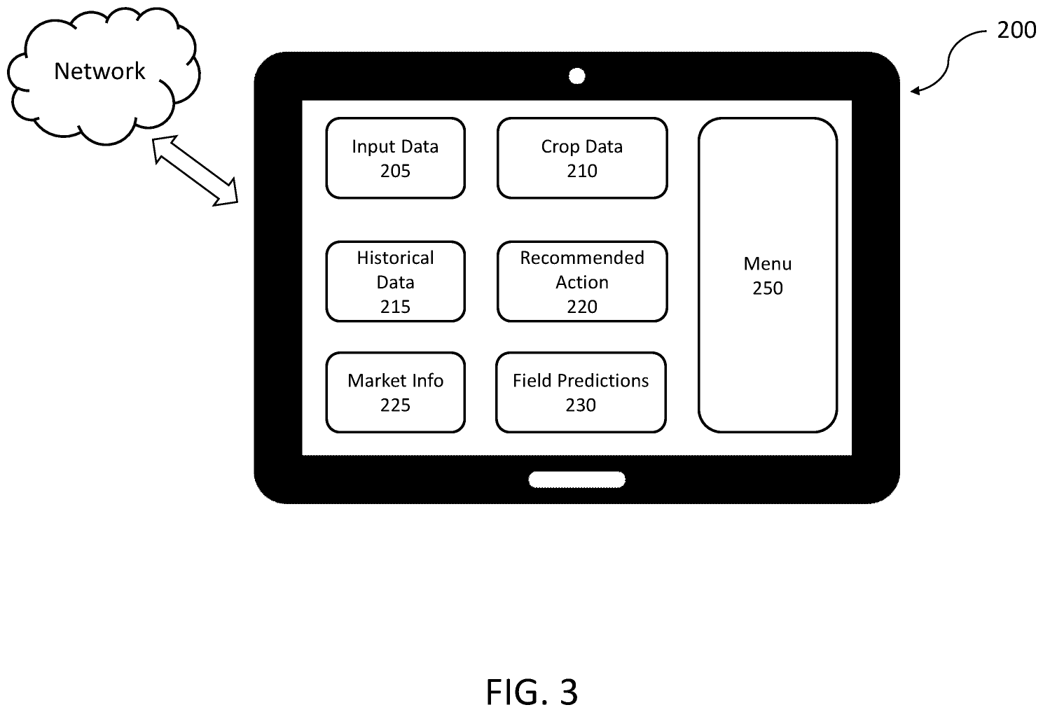

FIG. 3 shows a simplified example of a user interface for sending inputs and/or receiving outputs from the agricultural assistance system 500. The interface is shown on a computing device 200, which may be a computer, tablet, smartphone, other mobile device, or any other computing device capable of communicating with a network. A user may send or receive information to and from the agricultural assistance system 500 directly or through a network. A number of exemplary buttons (e.g., icons or physical buttons) are shown within the illustrated user interface, but any number of buttons may be used to access different features of agricultural assistance system 500. Additionally, the buttons may be in any configuration to allow a user access to different features of agricultural assistance system 500 (e.g., drop down menus, tables, nested menus). Buttons may include, but are not limited to, an input data button 205, crop data button 210, historical data button 215, recommended action button 220, market info button 225, field predictions button 230, and menu button 250.

The input data button 205 may allow a user to input data to agricultural assistance system 500 when pressed, including any of the inputs previously discussed. Crop data button 210 may allow a user to view data related to plants 105, including crop yield 512, crop health 513, crop type 514, spectral data from electromagnetic radiation sensor 110, land-based sensor 120, and/or aerial sensor 130, crop images, or any other relevant crop info. Historical data button 215 may allow a user to view or input historical data, such as historical data 507. Recommended action button 220 may allow a user to view a recommended action or actions, such as crop recommendation 511. Market info data button 225 may provide a user with market data 503. Field predictions button 230 may provide a user with predictions for a land 100, including crop yield 512 and potential profit 515. Menu button 250 may bring a user to a main menu or central hub of agricultural assistance system 500. Any of the data or information presented to a user may be done through any form of communication, including graphs, images, text, sounds, or any other sensory indicator.

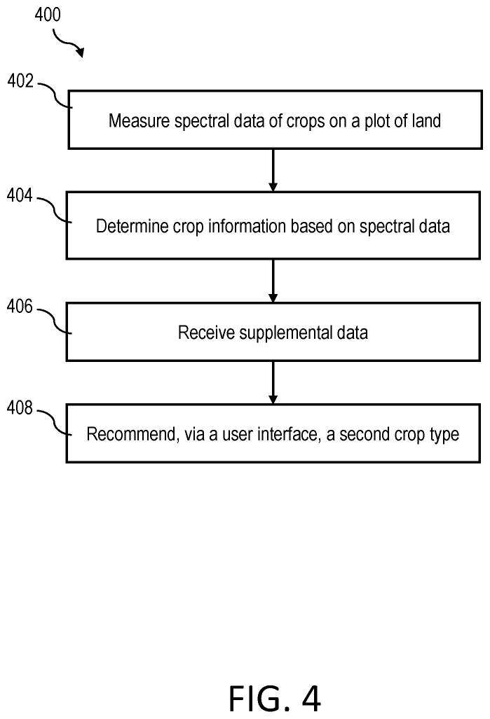

FIG. 4 shows a flow diagram of an embodiment of an overall method of operating agricultural assistance system 500, which in the illustrated embodiment is a recommendation method 400. Recommendation method 400 comprises a measuring step 402, a determining step 404, a receiving step 406, and a recommending step 408. The measuring step 402 comprises measuring spectral data of plants 105 (e.g. crops) for a plot of land 100. The determining step 404 comprises calculating crop information including a first crop type. The receiving step 406 comprises receiving supplemental data, such as the inputs to agricultural assistance system 500 as shown in FIG. 2.

The recommending step 408 comprises recommending to a user via a user interface a second crop type different from the first crop type. The recommendation method 400 is configured such that agricultural assistance system 500 can recommend that a user plant or harvest a different crop than one that is currently being grown. Such a system may be used to optimize the crop output for a plot of land or a region based on a desired production value or a nutrition level for a region or population. For example, recommendation method 400 can recommend a crop that provides more calories per land area than another crop type.

Computing System

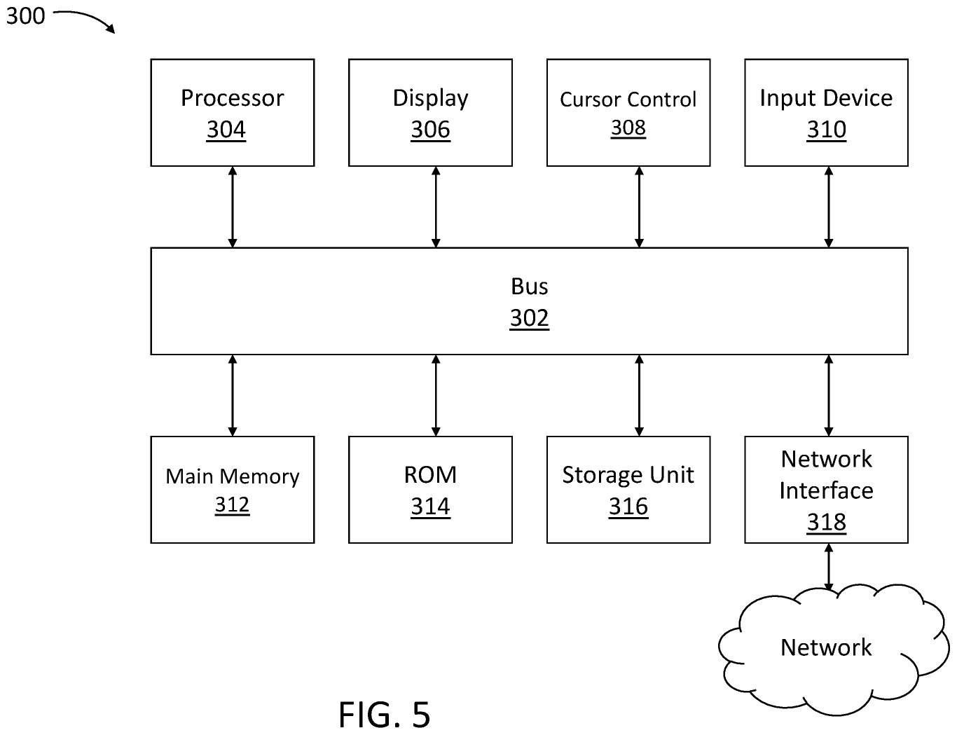

FIG. 5 shows a block diagram of illustrative components of a computer system 300 for carrying out aspects of the method 400 described above. For example, in some embodiments, prior to the processes (e.g., steps) of the method 400 being performed, additional processes occur which may be performed by the computing system 300. This diagram is merely an example, which should not unduly limit the scope of the claims.

The computing system 300 includes a bus 302 or other communication mechanism for communicating information between or among a processor 304, a display 306, a cursor control component 308, an input device 310, a main memory 312, a read only memory (ROM) 314, a storage unit 316, and/or a network interface 318. In some examples, the bus 302 is coupled to the processor 304, the display 306, the cursor control component 308, the input device 310, the main memory 312, the ROM 314, the storage unit 316, and/or the network interface 318. And, in certain examples, the network interface 318 is coupled to a network 320.

In some examples, the processor 304 includes one or more general purpose microprocessors. In some examples, the main memory 312 (e.g., random access memory (RAM), cache and/or other dynamic storage devices) is configured to store information and instructions to be executed by the processor 304. In certain examples, the main memory 312 is configured to store temporary variables or other intermediate information during execution of instructions to be executed by processor 304. For example, the instructions, when stored in the storage unit 316 accessible to processor 304, render the computing system 300 into a special-purpose machine that is customized to perform the operations specified in the instructions (e.g., the method 400). The main memory 312 can be considered to be a non-transitory computer-readable medium on which the instructions are stored for execution by the processor 304.

In some examples, the ROM 314 is configured to store static information and instructions for the processor 304. In certain examples, the storage unit 316 (e.g., a magnetic disk, optical disk, or flash drive) is configured to store information and instructions.

In some embodiments, the display 306 (e.g., an LCD display or a touch screen) is configured to display information to a user of the computing system 300. In some examples, the input device 310 (e.g., alphanumeric and other keys) is configured to communicate information and commands to the processor 304. For example, the cursor control 308 (e.g., a mouse, a trackball, or cursor direction keys) is configured to communicate additional information and commands (e.g., to control cursor movements on the display 306) to the processor 304.

In some embodiments, an agricultural assistance system as described can be used by a farmer, a land owner, a farm manager, an overseer of a number of plots of land, a governing body, or any other user associated with land 100 and growth of plants 105. In an exemplary embodiment, agricultural assistance system 500 is used by a user who oversees multiple plots of land 100, and agricultural assistance system 500 provides recommendations for each plot of land in order to optimize production.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

What is claimed is:

1. A method comprising:
measuring spectral data of crops on a plot of land via an electromagnetic radiation sensor;
determining crop information based on the spectral data, the crop information comprising a first crop type;
receiving supplemental data, the supplemental data comprising at least one of geographical data, climate data, weather data, soil data, or market data; and
recommending, via a user interface, a second crop type that is different than the first crop type to a first user based, at least in part, on the crop information and the supplemental data.

2. The method of claim 1, wherein the electromagnetic radiation sensor comprises at least one of a satellite and a drone.

3. The method of claim 2, wherein the spectral data comprises infrared wavelength data.

4. The method of claim 3, wherein the step of determining the crop information is carried out by comparing the spectral data to a table of spectral crop data, the table associating the spectral data with the crop information.

5. The method of claim 1, wherein the crop information further comprises a crop health and a crop yield.

6. The method of claim 1, wherein the step of recommending a suggested crop type is further based on a nutrition level for a population.

7. The method of claim 1, further comprising a step of aggregating crop information from a plurality of farms and providing the aggregated crop information to the second user.

8. A method for computing and distributing crop data comprising:
sensing spectral data for a plurality of crops on a plurality of farms via at least one satellite;
retrieving supplemental data comprising at least one of geographical data, climate data, weather data, soil data, market data, or historical data;
computing crop data for each of the plurality of farms based, at least in part, on the spectral data and supplemental data; and
sending the crop data of the plurality of farms to a user.

9. The method of claim 8, wherein the crop data comprises at least one of crop type, expected yield, or crop health.

10. The method of claim 9, further comprising the step of computing a potential profit based on the market data and the expected yield.

11. The method of claim 8, further comprising the step of recommending a crop type to the user based on the crop data and the supplemental data.

12. A system comprising:
a non-transitory computer-readable medium that contains instructions; and
one or more processors configured to execute the instructions to perform the following:
receive spectral data related to crops on a plot of land;
determine a crop type based on the spectral data;
retrieve supplemental data comprising at least one of geographical data, climate data, weather data, soil data, market data, or historical data;
determine crop information, in addition to the crop type, based on the supplemental data; and
provide the crop type and crop information to a user.

13. The system of claim 12, further comprising: a user interface, wherein each of the steps performed by the system may be initiated by the user through the user interface.

14. The system of claim 13, wherein the user interface comprises an input data button and a field prediction button.

15. The system of claim 14, wherein the input data button is configured to provide the user with an input field to provide at least part of the supplemental data to the system.

16. The system of claim 14, wherein the field prediction button provides the user with at least one of a crop yield and a potential profit.

17. The system of claim 12, wherein the one or more processors are also configured to execute the instructions to perform the following: aggregate the crop type and crop information for a plurality of plots of land.

18. The system of claim 12, further comprising: an electromagnetic radiation sensor configured to measure the spectral data.

19. The system of claim 12, further comprising: at least one of an aerial sensor and a land-based sensor configured to measure the spectral data.

20. The system of claim 12, wherein the supplemental data comprises at least one of geographical data, climate data, weather data, soil data, market data, and historical data.
